(19) United States
(12) Patent Application Publication
(10) Pub. No.: US 2026/0252515 A1
(43) Pub. Date: Aug. 27, 2026

(54) DISPLAY CARD MODULE AND ELECTRONIC DEVICE

(71) Applicant: ASUSTeK COMPUTER INC., Taipei City (TW)

(72) Inventors: Chih-Wei Shih, Taipei City (TW); Chun-Tse Chien, Taipei City (TW); Yuan-Yu Lin, Taipei City (TW)

(73) Assignee: ASUSTeK COMPUTER INC., Taipei City (TW)

(21) Appl. No.: 19/529,130

(22) Filed: Feb. 4, 2026

(30) Foreign Application Priority Data
Feb. 26, 2025 (CN) 202510217278.2

(51) Int. Cl. G06F 13/40

(52) U.S. Cl. CPC G06F 13/4022; G06F 2213/0026

(57) ABSTRACT

Provided is a display card module and an electronic device. The display card module includes a display card body, a graphics processor, first and second slots, first and second multiplex circuits. The display card body includes a golden finger component having first, second, third portions. The graphics processor is disposed on the display card body and electrically connected to the first portion. The first and second slots are disposed on the display card body. The first multiplex circuit is disposed on the display card body and controlled by a control signal to allow the second portion to switch between electrically connected to the graphics processor and electrically connected to the first slot. The second multiplex circuit is disposed on the display card body and controlled by the control signal to allow the third portion to switch between electrically connected to the graphics processor and electrically connected to the second slot.

### CROSS-REFERENCE TO RELATED APPLICATION

This application claims the priority benefit of China application serial no. 202510217278.2, filed on February 26, 2025. The entirety of the above-mentioned patent application is hereby incorporated by reference herein and made a part of this specification.

### BACKGROUND

### Technical Field

The disclosure relates to a display card module and an electronic device, particularly relates to a display card module having a slot and an electronic device having the display card module.

### Description of Related Art

With the advancement of technology development and the increasing requirements of users, electronic devices are gradually developing toward a thinner and lighter volume, causing the motherboard and other internal components of the electronic device to become more compact accordingly. However, this development also makes it difficult for users to optimize the performance of electronic devices. For example, due to the size limitations of ITX specification motherboards, the number of PCI-E slots or m.2 slots that can be disposed thereon is limited. In addition, according to different performance requirements, the channel settings of PCI-E interface used by low-end and high-end display cards are different. Typically, low-end display cards merely need to use half of the PCI-E interface (PCI-E x8) channels because they require narrower bandwidth, while high-end display cards need to use all channels of the PCI-E interface (PCI-E x16) due to the wider bandwidth requirements thereof, but in the current design, it is difficult to accommodate both types of cards.

### SUMMARY

The disclosure provides a display card module, which includes a display card body, a graphics processor, a first slot, a second slot, a first multiplex circuit, and a second multiplex circuit. The display card body includes a golden finger component, and the golden finger component has a first portion, a second portion, and a third portion. The graphics processor is disposed on the display card body and is electrically connected to the first portion. The first slot and the second slot are disposed on the display card body. The first multiplex circuit is disposed on the display card body and is controlled by a control signal to allow the second portion to switch between being electrically connected to the graphics processor and being electrically connected to the first slot. The second multiplex circuit is disposed on the display card body and is controlled by the control signal to allow the third portion to switch between being electrically connected to the graphics processor and being electrically connected to the second slot.

The disclosure further provides an electronic device, which includes a motherboard and the display card module. The motherboard includes a PCI-E slot. The display card module is detachably connected to the PCI-E slot.

Based on the above, the display card module and the electronic device of the disclosure can freely switch the channel settings of the PCI-E interface according to the performance characteristics of the display card, accommodating the bandwidth required by both low-end and high-end display cards, thus providing more flexibility.

To make the foregoing features and advantages of the disclosure more comprehensible, embodiments are specifically provided below with detailed explanations together with the accompanying drawings.

### BRIEF DESCRIPTION OF THE DRAWINGS

FIG. 1 is a schematic diagram showing a display card module inserted into a motherboard according to an embodiment of the disclosure.

FIG. 2 is a schematic diagram showing the display card module inserted into the motherboard according to another embodiment of the disclosure.

FIG. 3 is a flowchart of steps for a method of generating a control signal according to another embodiment of the disclosure.

### DESCRIPTION OF THE EMBODIMENTS

Reference will now be made in detail to exemplary embodiments of the disclosure, examples of the embodiments are illustrated in the accompanying drawings. Wherever possible, the same reference symbols are used in the drawings and descriptions to represent the same or similar parts.

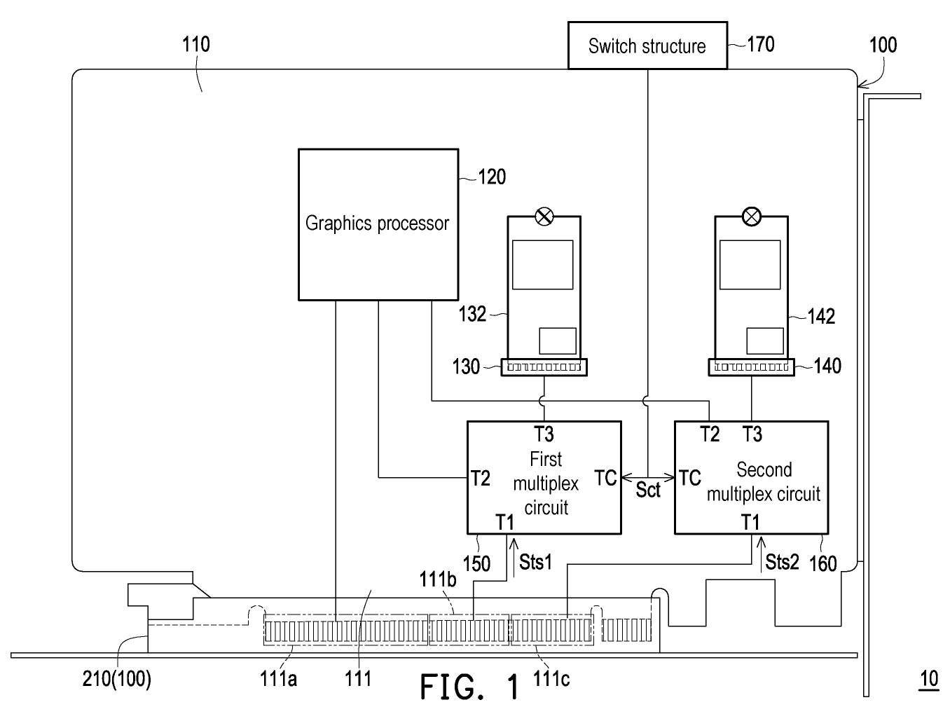

FIG. 1 is a schematic diagram showing a display card module inserted into a motherboard according to an embodiment of the disclosure. It should be noted that, for the sake of clarity and simplicity, FIG. 1 merely schematically shows the external outline of a display card body 110.

Referring to FIG. 1, an electronic device 10 of this embodiment includes a motherboard 200 and a display card module 100. The motherboard 200 includes a PCI-E slot 210. The display card module 100 is detachably connected to the PCI-E slot 210. In other embodiments, the display card module 100 may also be connected to other types of slots, and the disclosure does not limit the type of slot to which the display card module 100 is connected.

The display card module 100 includes a display card body 110, a graphics processor 120, a first slot 130, a second slot 140, a first multiplex circuit 150, a second multiplex circuit 160, and a switch structure 170. The display card body 110 includes a golden finger component 111, and the golden finger component 111 includes a first portion 111a, a second portion 111b, and a third portion 111c. In this embodiment, the channel of the golden finger component 111 is, for example, PCI-E x16, the channel of the first portion 111a is, for example, PCI-E x8, and the channels of the second portion 111b and the third portion 111c are, for example, PCI-E x4, but the disclosure is not limited thereto.

The graphics processor 120 is disposed on the display card body 110 and is electrically connected to the first portion 111a of the golden finger component 111. The first slot 130 and the second slot 140 are disposed on the display card body 110. The first slot 130 and the second slot 140 are, for example, m.2 slots, but the disclosure does not limit the types of the first slot 130 and the second slot 140 and the disposed positions thereof on the display card body 110.

The display card module 100 further includes a first external component 132 and a second external component 142. The first external component 132 is detachably plugged into the first slot 130. The second external component 142 is detachably plugged into the second slot 140. The first external component 132 and the second external component 142 include a solid state drive, an m.2-SATA adapter card, or an m.2-USB adapter card. In FIG. 1, the first external component 132 and the second external component 142 are shown as solid state drives, but the disclosure does not limit the types of the first external component 132 and the second external component 142, as long as they can be plugged into the first slot 130 or the second slot 140.

The first multiplex circuit 150 and the second multiplex circuit 160 are disposed on the display card body 110, and may be implemented by, for example, multiplexers. The first multiplex circuit 150 and the second multiplex circuit 160 each have a first terminal T1, a second terminal T2, a third terminal T3, and a switch terminal TC. For the first multiplex circuit 150, the first terminal T1 is electrically connected to the second portion 111b, the second terminal T2 is electrically connected to the graphics processor 120, and the third terminal T3 is electrically connected to the first slot 130. For the second multiplex circuit 160, the first terminal T1 is electrically connected to the third portion 111c, the second terminal T2 is electrically connected to the graphics processor 120, and the third terminal T3 is electrically connected to the second slot 140. The switch terminals TC of the first multiplex circuit 150 and the second multiplex circuit 160 receive a control signal Sct, and determine whether their first terminal T1 is electrically connected to the second terminal T2 or the third terminal T3 according to the control signal Sct. As a result, the first multiplex circuit 150 may be controlled by the control signal Sct to allow the second portion 111b to switch between being electrically connected to the graphics processor 120 and being electrically connected to the first slot 130, while the second multiplex circuit 160 may be controlled by the control signal Sct to allow the third portion 111c to switch between being electrically connected to the graphics processor 120 and being electrically connected to the second slot 140.

The switch structure 170 is disposed on the display card body 110 (for example, at the edge) and is electrically connected to the first multiplex circuit 150 and the second multiplex circuit 160. In one embodiment, the switch structure 170 is a toggle switch that may be adjusted by the user to a first position or a second position on the display card body 110 according to the PCI-E interface setting desired by the user, and generates the control signal Sct according to the adjusted position. It should be noted that the PCI-E interface referred to here is the signal transmission mode between the display card module 100 and the motherboard 200 (including a performance mode and a storage mode), rather than the specific slot structure. In one embodiment, in the performance mode, the channel of the PCI-E interface is PCI-E x16 and is entirely used by the graphics processor 120 to maximize the performance of the graphics processor 120 (for example, to provide a complete gaming experience with optimal performance) in accordance with the settings in the Basic Input/Output System (BIOS) of the motherboard 200. In the storage mode, the channel of the PCI-E interface is, for example, divided into one PCI-E x8 and two PCI-E x4, with the PCI-E x8 used by the graphics processor 120, and the two PCI-E x4 used by the first external component 132 on the first slot 130 and the second external component 142 on the second slot 140 respectively, to enhance the performance of the electronic device 10 (for example, improving and increasing storage performance) through the display card module 100 in accordance with the settings in the BIOS of the motherboard 200.

Furthermore, when the switch structure 170 is adjusted by the user to the first position, the operation indicates that the PCI-E interface is set to the performance mode. At this time, the switch structure 170 outputs the control signal Sct with a first logic level to the first multiplex circuit 150 and the second multiplex circuit 160. When the received control signal Sct is at the first logic level, the first multiplex circuit 150 and the second multiplex circuit 160 respectively switch the first terminals T1 thereof to be electrically connected to the corresponding second terminals T2. With this setting, in addition to the first portion 111a of the golden finger component 111, the second portion 111b and the third portion 111c of the golden finger component 111 are also electrically connected to the graphics processor 120. The graphics processor 120 is electrically connected to the motherboard 200 through the first portion 111a, the second portion 111b, and the third portion 111c of the golden finger component 111, allowing all channels of the PCI-E interface to be used by the graphics processor 120, thereby implementing the performance mode.

When the switch structure 170 is adjusted by the user to the second position different from the first position, the operation indicates that the PCI-E interface is set to the storage mode. At this time, the switch structure 170 outputs the control signal Sct with a second logic level to the first multiplex circuit 150 and the second multiplex circuit 160. When the received control signal Sct is at the second logic level, the first multiplex circuit 150 and the second multiplex circuit 160 respectively switch the first terminals T1 thereof to be electrically connected to the corresponding third terminals T3. With this setting, the second portion 111b and the third portion 111c of the golden finger component 111 are respectively electrically connected to the first external component 132 on the first slot 130 and the second external component 142 on the second slot 140. The graphics processor 120 is electrically connected to the motherboard 200 merely through the first portion 111a of the golden finger component 111, while the first external component 132 and the second external component 142 are respectively electrically connected to the motherboard 200 through the second portion 111b and the third portion 111c of the golden finger component 111, allowing half of the channels of the PCI-E interface (PCI-E x8) to be used by the graphics processor 120, and the remaining channels of the PCI-E interface (two PCI-E x4) to be used by the first external component 132 and the second external component 142, thereby implementing the storage mode.

Through this design, the channel settings of the PCI-E interface can be freely switched according to the performance characteristics of the display card, accommodating the bandwidth required by both low-end and high-end display cards, thus providing more flexibility. In addition, since the slots on the motherboard 200 do not need to be modified to enhance the performance of the electronic device 10, the experience of the user when enhancing the performance of the electronic device 10 is not affected.

Incidentally, the first logic level may be logic value 1 or 0, and the second logic level may be the complementary logic value 0 or 1 to the first logic level, and the disclosure is not limited thereto.

In an embodiment, the first multiplex circuit 150 may re-drive a first transmission signal Sts1 received from the second portion 111b of the golden finger component 111 through related circuits such as signal amplifiers configured internally. The second multiplex circuit 160 may re-drive a second transmission signal Sts2 received from the third portion 111c of the golden finger component 111 through related circuits such as signal amplifiers configured internally. In this way, even though the second portion 111b and the third portion 111c of the golden finger component 111 are located farther from the graphics processor 120 with longer routing distances, the first multiplex circuit 150 and the second multiplex circuit 160 may respectively reconstruct the first transmission signal Sts1 and the second transmission signal Sts2, not only increasing gain but also restoring the waveform, thereby meeting the signal requirements of the PCIe 5.0 standard.

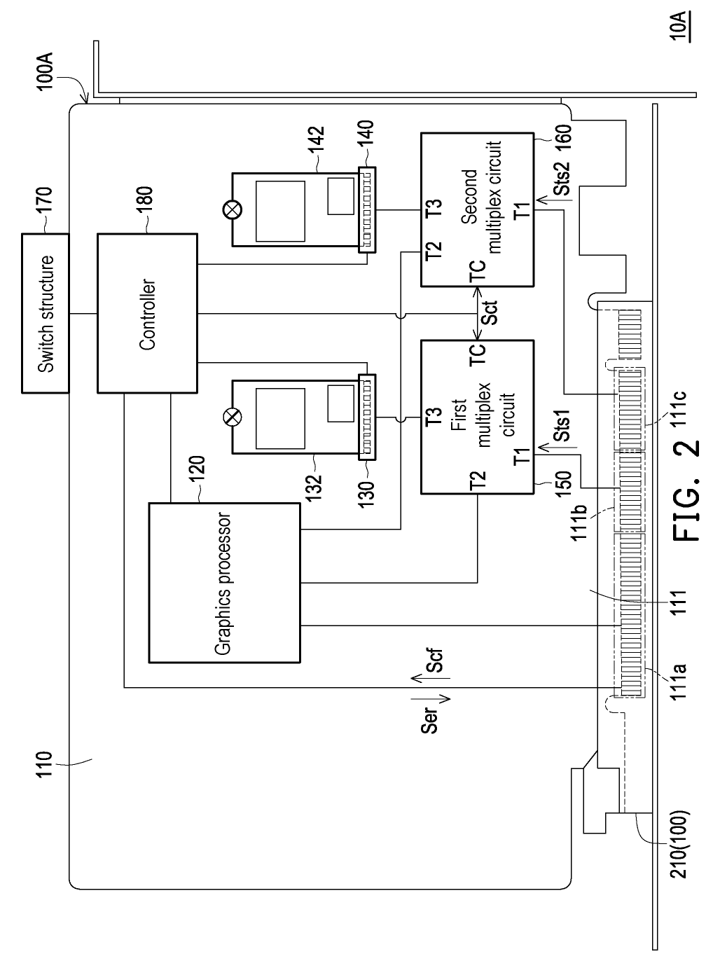

In an embodiment, a controller may also be disposed on the display card body, and the control signal Sct may be adjusted through the controller. In detail, referring to FIG. 2, an electronic device 10A of this embodiment includes the motherboard 200 and a display card module 100A. The motherboard 200 includes a PCI-E slot 210. The display card module 100A is detachably connected to the PCI-E slot 210. The display card module 100A includes the display card body 110, the graphics processor 120, the first slot 130, the second slot 140, the first multiplex circuit 150, the second multiplex circuit 160, and the switch structure 170. The implementation methods of the foregoing components are the same as or similar to the implementation methods of the respective components on the display card module 100 in the foregoing embodiments, so details will not be repeated here.

Different from the foregoing embodiments, the display card module 100A further includes a controller 180. The controller 180 is disposed on the display card body 110 and is electrically connected to the golden finger component 111, the graphics processor 120, the first slot 130, the second slot 140, the first multiplex circuit 150, the second multiplex circuit 160, and the switch structure 170. The controller 180 may be implemented by an embedded controller (EC) or a microcontroller. In this implementation, the control signal Sct is not directly generated by the switch structure 170, but is generated by the controller 180 according to the status of the first slot 130 and the second slot 140 and the position of the switch structure 170.

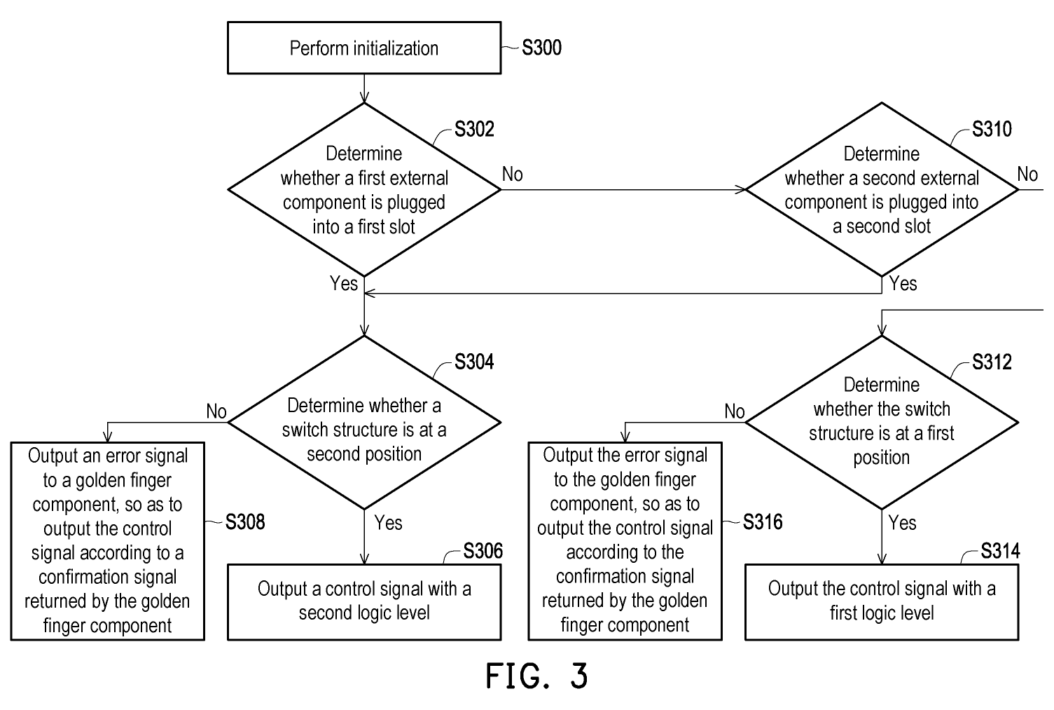

Referring to FIG. 2 together with FIG. 3, the following describes the steps of the method for generating the control signal Sct in this embodiment in conjunction with the components in the display card module 100A. First, in Step S300, the controller 180 performs initialization. For example, the controller 180 may initialize the General-purpose input/output (GPIO) and Inter-Integrated Circuit (I²C) related to the first slot 130, the second slot 140, and the switch structure 170. In an embodiment, if an initialization error occurs, the controller 180 may set up a notification device (such as an LED light or speaker) installed on the housing of the display card module 100A or the electronic device 10A to notify the user of the abnormality through flashing lights, playing sounds, or generating vibrations.

Next, in Step S302, the controller 180 determines whether the first external component 132 is plugged into the first slot 130. For example, the controller 180 may confirm whether the GPIO pin corresponding to the first slot 130 is pulled low. If yes, then it is indicated that the first external component 132 is plugged into the first slot 130. If no, then it is indicated that the first external component 132 is not plugged into the first slot 130.

When the first external component 132 is plugged into the first slot 130, in Step S304, the controller 180 determines whether the switch structure 170 is at the second position. For example, the controller 180 may confirm whether the GPIO pin corresponding to the switch structure 170 is pulled low. If yes, then it is indicated that the switch structure 170 is at the second position. If no, then it is indicated that the switch structure 170 is not at the second position.

When the switch structure 170 is at the second position, in Step S306, the controller 180 outputs the control signal Sct with the second logic level to the first multiplex circuit 150 and the second multiplex circuit 160. Thereby, the first multiplex circuit 150 and the second multiplex circuit 160 respectively switch the first terminals T1 thereof to be electrically connected to the corresponding third terminals T3, so that the second portion 111b and the third portion 111c of the golden finger component 111 are respectively electrically connected to the first external component 132 on the first slot 130 and the second external component 142 on the second slot 140, thus implementing the storage mode.

When the switch structure 170 is not at the second position, in Step S308, the controller 180 outputs an error signal Ser to the golden finger component 111, so as to output the control signal Sct to the first multiplex circuit 150 and the second multiplex circuit 160 according to a confirmation signal Scf returned by the golden finger component 111. For example, the golden finger component 111 may transmit the error signal Ser to the processor on the motherboard 200, so that the display device of the electronic device 10A displays a check error message indicating that the position of the switch structure 170 does not match the status of the slot. At the same time, options may be provided on the display device of the electronic device 10A for the user to select, allowing the user to decide whether the current PCI-E interface should be set to the performance mode or the storage mode.

According to the option selected by the user, the processor on the motherboard 200 returns the confirmation signal Scf to the controller 180 through the golden finger component 111. Thereby, the controller 180 may output the corresponding control signal Sct to the first multiplex circuit 150 and the second multiplex circuit 160 based on the confirmation signal Scf, to implement the mode needed by the user.

On the other hand, when in Step S302 the controller 180 determines that the first external component 132 is not plugged into the first slot 130, in Step S310, the controller 180 determines whether the second external component 142 is plugged into the second slot 140. For example, the controller 180 may confirm whether the GPIO pin corresponding to the second slot 140 is pulled low. If yes, then it is indicated that the second external component 142 is plugged into the second slot 140. If no, then it is indicated that the second external component 142 is not plugged into the second slot 140.

When the second external component 142 is plugged into the second slot 140, Step S304 is proceeded to continue processing.

When the second external component 142 is not plugged into the second slot 140, in Step S312, the controller 180 determines whether the switch structure 170 is at the first position. For example, the controller 180 may confirm whether the GPIO pin corresponding to the switch structure 170 is pulled high. If yes, then it is indicated that the switch structure 170 is at the first position. If no, then it is indicated that the switch structure 170 is not at the first position.

When the switch structure 170 is at the first position, in Step S314, the controller 180 outputs the control signal Sct with the first logic level to the first multiplex circuit 150 and the second multiplex circuit 160. Thereby, the first multiplex circuit 150 and the second multiplex circuit 160 respectively switch the first terminals T1 thereof to be electrically connected to the corresponding second terminals T2, so that the second portion 111b and the third portion 111c of the golden finger component 111 are also electrically connected to the graphics processor 120, thus implementing the performance mode.

When the switch structure 170 is not at the first position, in Step S316, the controller 180 outputs the error signal Ser to the golden finger component 111, to output the control signal Sct to the first multiplex circuit 150 and the second multiplex circuit 160 according to the confirmation signal Scf returned by the golden finger component 111.

In summary, the display card module and the electronic device of the disclosure can freely switch the channel settings of the PCI-E interface according to the performance characteristics of the display card, accommodating the bandwidth required by both low-end and high-end display cards, thus providing more flexibility. In addition, even when located far from the graphics processor with longer routing distances, the display card module and the electronic device of the disclosure may also reconstruct the transmitted signals through re-driving, thereby meeting the signal requirements of the PCIe 5.0 standard.

Finally, it should be noted that the foregoing embodiments are merely used to explain the technical solutions of the disclosure, and the embodiments are not to limit the disclosure. Although the disclosure has been described in detail with reference to the foregoing embodiments, persons skilled in the art should understand that they may still modify the technical solutions recorded in the foregoing embodiments, or equivalently replace part or all of the technical features; and these modifications or replacements do not make the essence of the corresponding technical solutions deviate from the scope of the technical solutions of the embodiments of the disclosure.

What is claimed is:

1. A display card module, comprising:
a display card body comprising a golden finger component, wherein the golden finger component has a first portion, a second portion, and a third portion;
a graphics processor disposed on the display card body and electrically connected to the first portion;
a first slot and a second slot disposed on the display card body;
a first multiplex circuit disposed on the display card body, and controlled by a control signal to allow the second portion to switch between being electrically connected to the graphics processor and being electrically connected to the first slot; and
a second multiplex circuit disposed on the display card body, and controlled by the control signal to allow the third portion to switch between being electrically connected to the graphics processor and being electrically connected to the second slot.

2. The display card module according to claim 1, wherein the first multiplex circuit re-drives a first transmission signal received from the second portion, and the second multiplex circuit re-drives a second transmission signal received from the third portion.

3. The display card module according to claim 1, wherein the first multiplex circuit and the second multiplex circuit each have a first terminal, a second terminal, a third terminal, and a switch terminal,
the first terminal of the first multiplex circuit is electrically connected to the second portion, the second terminal of the first multiplex circuit is electrically connected to the graphics processor, and the third terminal of the first multiplex circuit is electrically connected to the first slot,
the first terminal of the second multiplex circuit is electrically connected to the third portion, the second terminal of the second multiplex circuit is electrically connected to the graphics processor, the third terminal of the second multiplex circuit is electrically connected to the second slot, and the switch terminal of the first multiplex circuit and the second multiplex circuit receive the control signal.

4. The display card module according to claim 3, wherein in response to the control signal being at a first logic level, the first multiplex circuit and the second multiplex circuit respectively switch the first terminals thereof to be electrically connected to the corresponding second terminals, and in response to the control signal being at a second logic level, the first multiplex circuit and the second multiplex circuit respectively switch the first terminals thereof to be electrically connected to the corresponding third terminals.

5. The display card module according to claim 1, wherein the first slot and the second slot are m.2 slots.

6. The display card module according to claim 1, further comprising a first external component detachably plugged into the first slot.

7. The display card module according to claim 6, further comprising a second external component detachably plugged into the second slot, wherein the first external component and the second external component comprise a solid state drive, an m.2-SATA adapter card, or an m.2-USB adapter card.

8. The display card module according to claim 1, wherein a channel of the golden finger component is PCI-E x16, a channel of the first portion is PCI-E x8, and a channel of the second portion and a channel of the third portion are PCI-E x4.

9. The display card module according to claim 1, further comprising:
a switch structure disposed on the display card body and electrically connected to the first multiplex circuit and the second multiplex circuit, wherein the switch structure is adjusted to a first position or a second position to generate the control signal.

10. The display card module according to claim 9, wherein in response to the switch structure being adjusted to the first position, the switch structure outputs the control signal with a first logic level to the first multiplex circuit and the second multiplex circuit, and in response to the switch structure being adjusted to the second position, the switch structure outputs the control signal with a second logic level to the first multiplex circuit and the second multiplex circuit.

11. The display card module according to claim 1, further comprising:
a switch structure disposed on the display card body and adjusted to a first position or a second position; and
a controller disposed on the display card body, electrically connected to the golden finger component, the graphics processor, the first slot, the second slot, the first multiplex circuit, the second multiplex circuit, and the switch structure, and generating the control signal according to a status of the first slot and the second slot and a position of the switch structure.

12. The display card module according to claim 11, wherein the controller determines whether a first external component is plugged into the first slot, the controller determines whether the switch structure is at the second position in response to the first external component being plugged into the first slot, and the controller outputs the control signal with a second logic level to the first multiplex circuit and the second multiplex circuit in response to the switch structure being at the second position.

13. The display card module according to claim 12, wherein in response to the switch structure being not at the second position, the controller outputs an error signal to the golden finger component, so as to output the control signal to the first multiplex circuit and the second multiplex circuit according to a confirmation signal returned by the golden finger component.

14. The display card module according to claim 12, wherein the controller determines whether a second external component is plugged into the second slot in response to the first external component being not plugged into the first slot, the controller determines whether the switch structure is at the second position in response to the second external component being plugged into the second slot, and the controller outputs the control signal with the second logic level to the first multiplex circuit and the second multiplex circuit in response to the switch structure being at the second position.

15. The display card module according to claim 14, wherein in response to the switch structure being not at the second position, the controller outputs an error signal to the golden finger component, so as to output the control signal to the first multiplex circuit and the second multiplex circuit according to a confirmation signal returned by the golden finger component.

16. The display card module according to claim 14, wherein the controller determines whether the switch structure is at the first position in response to the second external component being not plugged into the second slot, and the controller outputs the control signal with a first logic level to the first multiplex circuit and the second multiplex circuit in response to the switch structure being at the first position.

17. The display card module according to claim 16, wherein in response to the switch structure being not at the first position, the controller outputs an error signal to the golden finger component, so as to output the control signal to the first multiplex circuit and the second multiplex circuit according to a confirmation signal returned by the golden finger component.

18. An electronic device, comprising:
a motherboard comprising a PCI-E slot; and
the display card module according to claim 1 detachably connected to the PCI-E slot.
